(19) United States
(12) Patent Application Publication
(10) Pub. No.: US 2016/0292278 A1
(43) Pub. Date: Oct. 6, 2016

(54) Coincidental Searching and Browsing

(71) Applicant: Lenovo (Singapore) Pte. Ltd., Singapore (SG)

(72) Inventors: John C. Mese, Cary, NC (US); Joshua N. Novak, Wake Forest, NC (US); Russell S. VanBlon, Raleigh, NC (US)

(21) Appl. No.: 14/672,848

(22) Filed: Mar. 30, 2015

(51) Int. Cl. G06F 17/30

(52) U.S. Cl. CPC G06F 17/30867; G06F 17/3053

(57) ABSTRACT

An approach is provided that identifies a first user of an online session. The first user being associated with a first set of user metadata. Receiving a request at the online session. Comparing the request to the first set of user metadata. Associating the request to the first set of user metadata in response to the comparison revealing that the request pertains to the first set of user metadata.

### BACKGROUND

Online search engine services gather information about a user based on what search terms they use as well as what websites they visit. This data is associated with the user in a profile that cannot easily be accessed by a user. If a user searches for a juvenile toy on behalf of their son or daughter, the parent is identified with their profile as a fan or otherwise interested in such juvenile content. The search engine service may then display content, suggestions, or advertisements related to the juvenile toy that likely does not apply to the parent or the parent's actual interests.

### SUMMARY

An approach is provided that identifies a first user of an online session. The first user being associated with a first set of user metadata. Receiving a request at the online session. Comparing the request to the first set of user metadata. Associating the request to the first set of user metadata in response to the comparison revealing that the request pertains to the first set of user metadata.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a flowchart showing the steps taken when a browser session is initiated;

FIG. 4 is a flowchart showing steps to handle user actions performed during the browser session;

FIG. 5 is a flowchart showing steps taken when a low confidence action is performed by the user; and

FIG. 6 is a flowchart showing steps taken to prompt a user when certain higher confidence actions are performed during the browser session.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. As used herein, a computer readable storage medium does not include a transitory signal.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

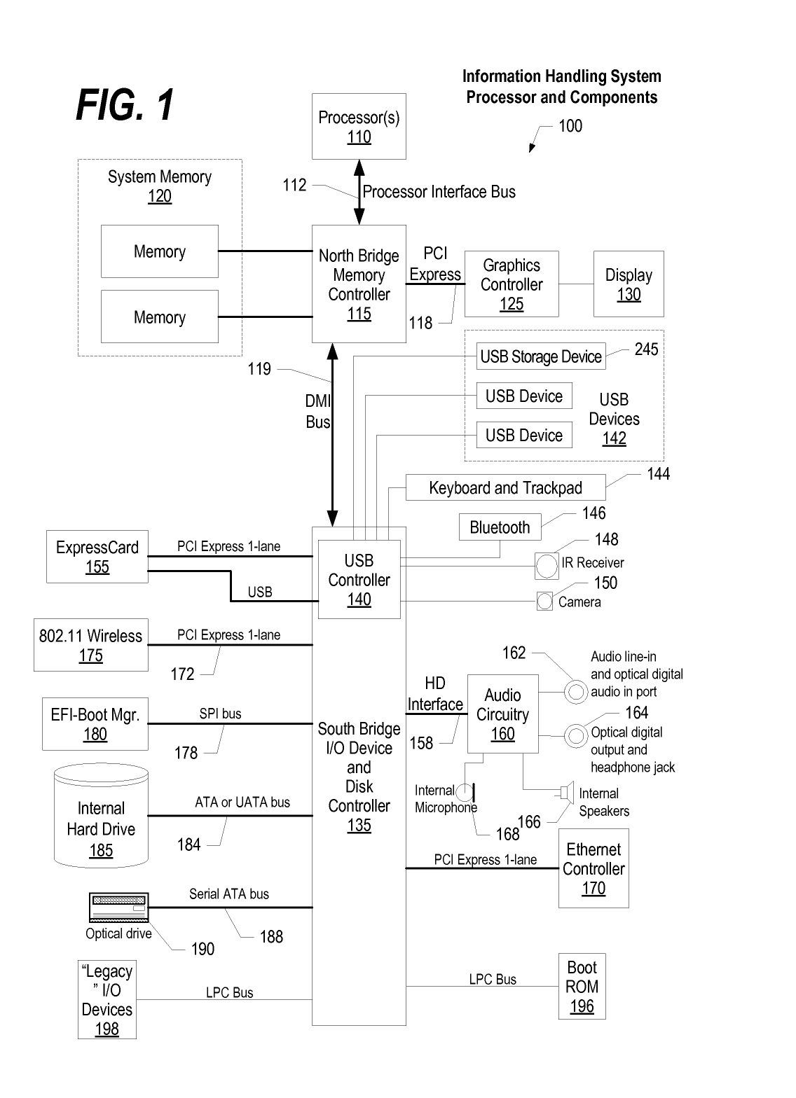

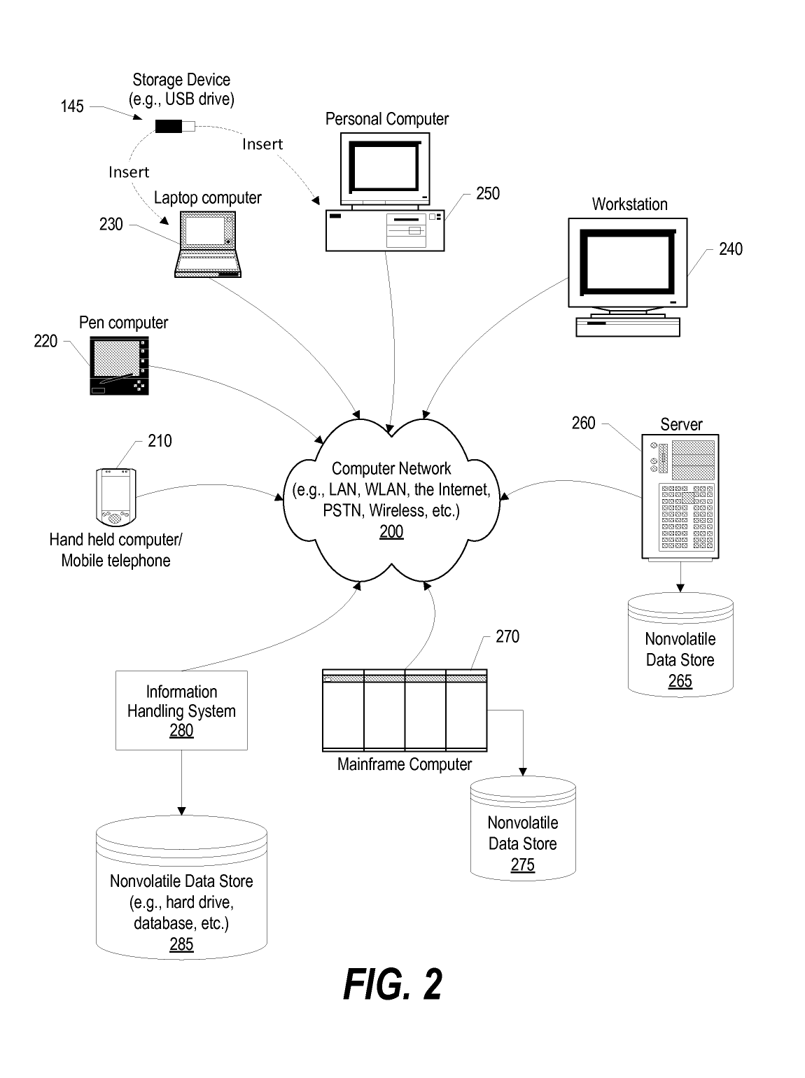

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

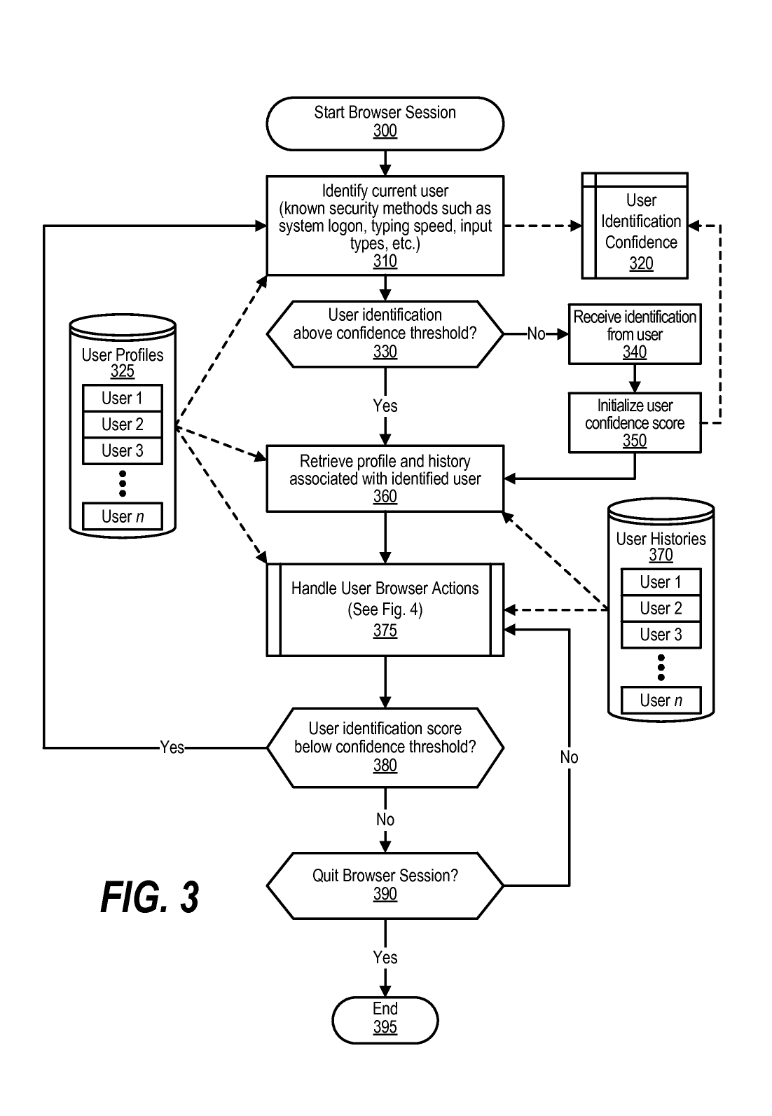

FIG. 3 is a flowchart showing the steps taken when a browser session is initiated. FIG. 3 commences at 300 and shows the steps taken by a process that performs coincidental searching and browsing. At step 310, the process identifies the current user of the browser session. The identification can be performed using known security methods such as system logon, typing speed, input types, and the like. A confidence score pertaining to the confidence that the correct user has been identified for the browser session is also generated at step 310 and this confidence score is stored in memory area 320.

The process determines as to whether the user identification confidence score is above an established confidence threshold (decision 330). If the user identification confidence score is above an established confidence threshold, then decision 330 branches to the ‘yes’ branch bypassing steps 340 and 350. On the other hand, if the user identification confidence score is below the confidence threshold, then decision 330 branches to the ‘no’ branch to perform steps 340 and 350. At step 340, the process receives the identification from user. In one embodiment, the user selects the identity from the set of user profiles stored in data store 325. At step 350, the process initializes the user confidence score to a high value since the user provided the identification information. The user confidence score is stored in memory area 320.

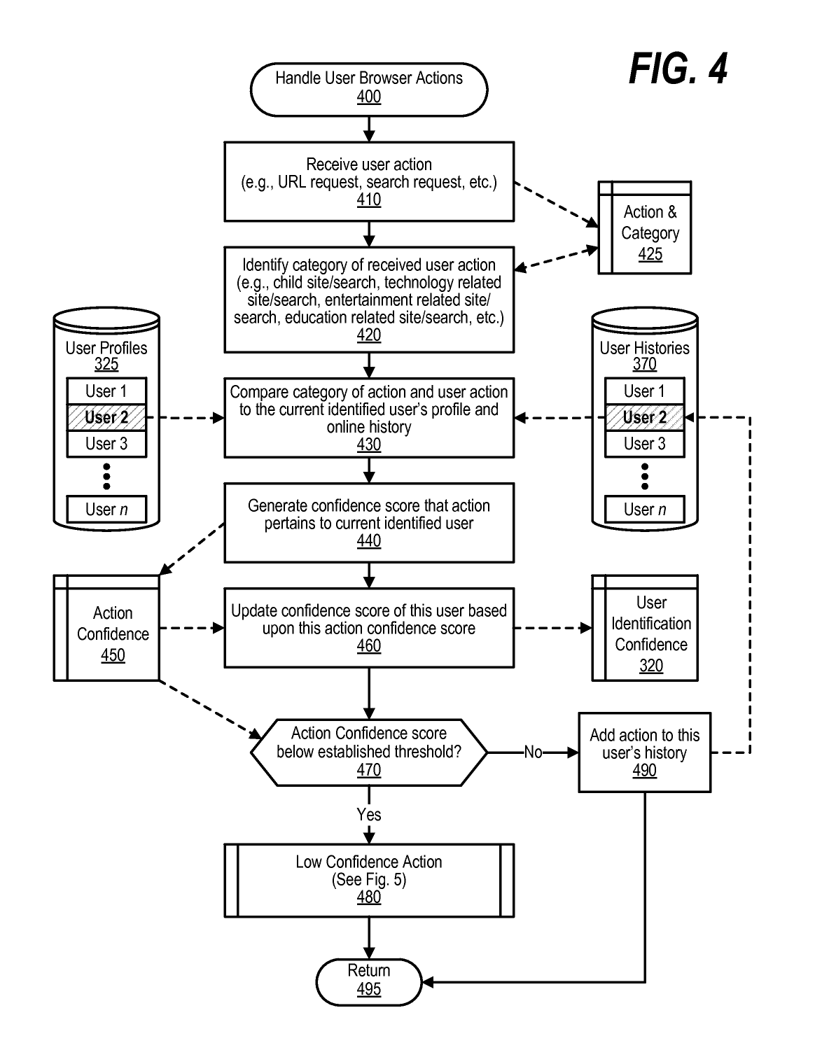

At step 360, the process retrieves the profile and browsing history associated with the identified user. The browsing history can include websites frequently visited and online searches performed by the identified user. The user profile is retrieved from profile data store 325 where a number of user profiles are stored. The user history is retrieved from histories data store 370 where a number of histories pertaining to a number of users are maintained. At predefined process 375, the process performs the Handle User Browser Actions routine (see FIG. 4 and corresponding text for processing details). Predefined process 375 utilizes the user's metadata, such as the user's profile and history, to determine if actions performed at the browser session pertain to the identified user or are being performed by, or on behalf of, another user.

During use of the browser, the user of the browser may change with one user replacing the original user of the browser. When this occurs, the identification confidence score of the user might be changed by predefined process 375. The process determines as to whether the user identification score has fallen below the confidence threshold (decision 380). If the user identification score has fallen below the confidence threshold, then decision 380 branches to the ‘yes’ branch which loops back to step 310 to identify the current user of the system. On the other hand, if the user identification score has not fallen below the confidence threshold, indicating that the original user is likely still operating the browser session, then decision 380 branches to the ‘no’ branch for further processing.

The process determines as to whether the browser session has been closed or otherwise terminated (decision 390). If the browser session has not been closed or otherwise terminated, then decision 390 branches to the ‘no’ branch which loops back to continue handling user browser actions using predefined process 375. This looping continues until the browser session has been closed or otherwise terminated, at which point decision 390 branches to the ‘no’ branch and processing ends at 395.

FIG. 4 is a flowchart showing steps to handle user actions performed during the browser session. FIG. 4 commences at 400 and shows the steps taken by a process that handles user actions received at a browser session. At step 410, the process receives a user action requested by the user of the browser session. For example, the action could be a request for a URL, a search request, etc. The user action is stored in memory area 425.

At step 420, the process identifies a category of the received user action. For example, the action may pertain to a child or juvenile site or search, a technology related site or search, an entertainment related site or search, an education related site or search, etc. The category pertaining to the user action is also stored in memory area 425. At step 430, the process compares the category of the action and the user action to the set of user metadata (e.g., user profile, user history, etc.) pertaining to the current identified user. As shown, step 430 can utilize the user profile from data store 325 as well as the user's history from data store 370. At step 440, the process generates a confidence score regarding whether the received user action pertains to current identified user. The confidence score is based on the comparison performed at step 430 and the score is stored in memory area 450. At step 460, the process updates the user identification confidence score of this user based upon this action confidence score. For example, if the user identification confidence score started at a value of 100 and the received action does not pertain to the identified user, then the user identification confidence score could be decreased, such as to 90.

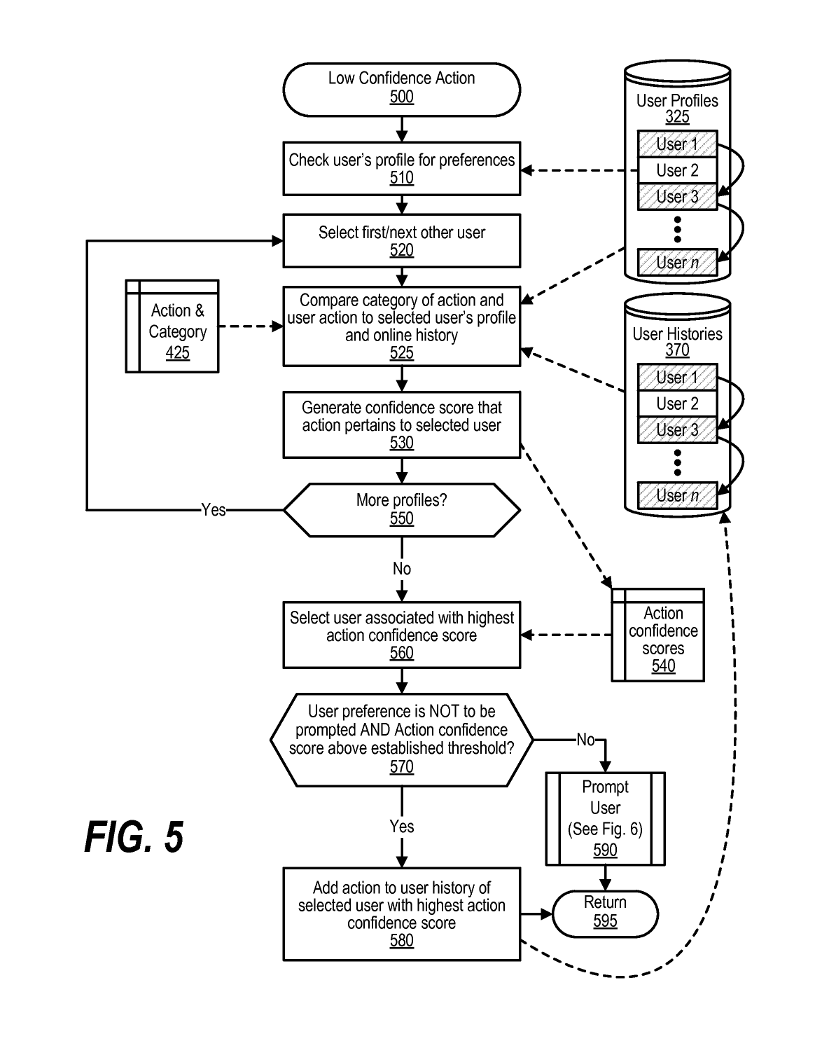

If the confidence score degrades below the threshold discussed in FIG. 3, then the process shown in FIG. 3 will attempt to re-identify the current user of the browser session. Likewise, if the action confidence indicates that the action pertains to the current user, then step 460 can be used to increase the user confidence value, such as from 90 to 100. The process determines as to whether the action confidence score is below established threshold indicating that the action likely does not pertain to the identified user (decision 470). If the action confidence score is below established threshold, then decision 470 branches to the ‘yes’ branch whereupon, at predefined process 480, the Low Confidence Action routine is performed (see FIG. 5 and corresponding text for processing details). On the other hand, if the action confidence score is above the established threshold, then decision 470 branches to the ‘no’ branch whereupon, at step 490, the action is added to the identified user's user history record. FIG. 4 processing thereafter returns to the calling routine (see FIG. 3) at 495.

FIG. 5 is a flowchart showing steps taken when a low confidence action is performed by the user. FIG. 5 commences at 500 and shows the steps taken by a process that executes when a low confidence action is encountered signaling that the action was taken either by, or on behalf of, another user. At step 510, the process checks the user's profile from data store 325 for the user's preferences. These preferences might include other users to check as well as whether the user wishes to be prompted when a low confidence action is encountered.

At step 520, the process selects metadata pertaining to the first other user. The metadata is selected from user profile data store 325 and user history data store 370. At step 525, the process compares the category of action and requested user action from memory area 425 to the selected user's metadata (e.g., the user's profile and online history, etc.). At step 530, based on the comparison, the process generates a confidence score of the action pertaining to the selected user. The generated action confidence scores are stored in memory area 540 with respect to each of the other users that are analyzed. The process determines as to whether there are more sets of user metadata to process (decision 550). If, there are more sets of user metadata to process, then decision 550 branches to the ‘yes’ branch which loops back to select the metadata pertaining to the next other user and analyzes the action and category with respect to the newly selected user as described above. This looping continues until there are no more sets of user metadata to process, at which point decision 550 branches to the ‘no’ branch for further processing.

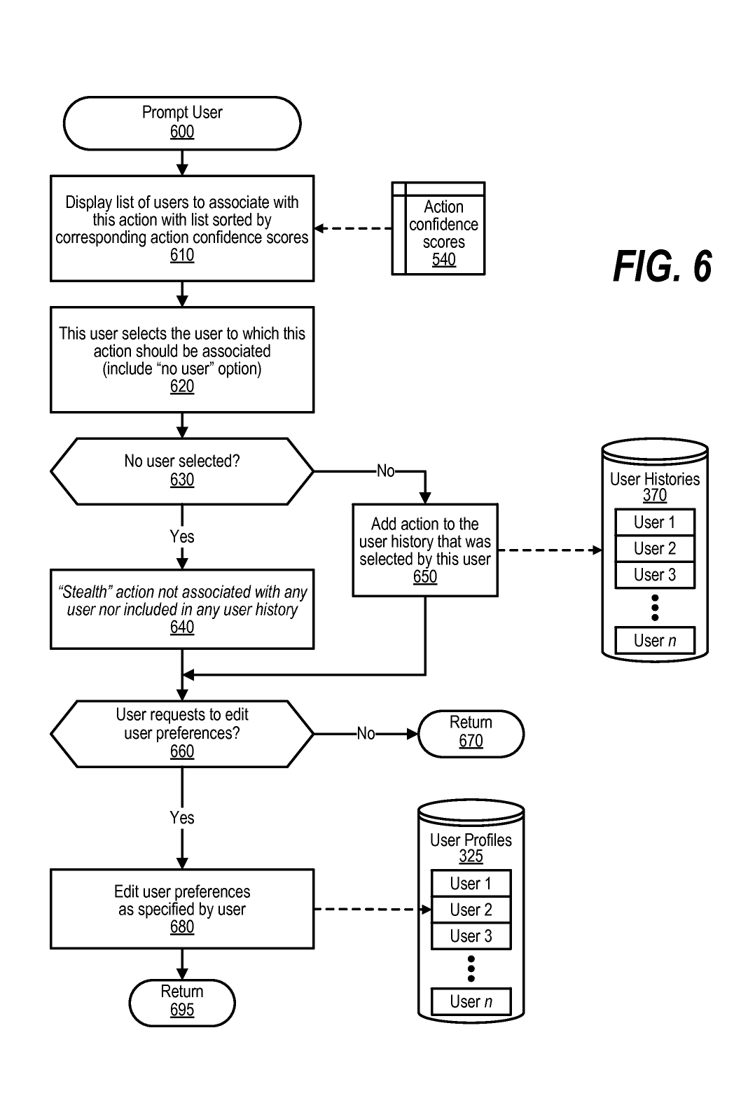

At step 560, the process selects the other user that received the highest action confidence score from memory area 540. The process determines as to whether the user has set a preference indicating that the user is not to be prompted and the action confidence score is above an established threshold (decision 570). If the user has set a preference indicating that the user is not to be prompted and the action confidence score is above an established threshold, then decision 570 branches to the ‘yes’ branch whereupon, at step 580 the process adds the action to the user history of the selected other user with the highest action confidence score. On the other hand, if the user has set a preference indicating that the user is be prompted, then decision 570 branches to the ‘no’ branch whereupon, at predefined 590, the process performs the Prompt User routine to receive the user identity associated with the action from the user (see FIG. 6 and corresponding text for processing details). FIG. 5 processing thereafter returns to the calling routine (see FIG. 4) at 595.

FIG. 6 is a flowchart showing steps taken to prompt a user when certain higher confidence actions are performed during the browser session. FIG. 6 commences at 600 and shows the steps taken by a process that prompts the user for the identity of the user to which a browser action applies. At step 610, the process displays a list of the possible users to associate with this action with list being sorted by the corresponding action confidence scores computed at step 530 in FIG. 5. At step 620, the current user selects the user to which this browser action should be associated.

In one embodiment, a ‘no user’ option is included. The process determines as to whether no user was selected by the user (decision 630). If no user was selected by the user, then decision 630 branches to the ‘yes’ branch whereupon, at step 640, the action is noted as a ‘stealth’ action and is not associated with any user nor included in any user history. On the other hand, if a user was selected by the user, then decision 630 branches to the ‘no’ branch whereupon, at step 650, the process adds the received browser action to the user history that was selected by this user.

The process determines as to whether the user has requested to edit the user's preferences (decision 660). If the user has requested to edit the user's preferences, then decision 660 branches to the ‘yes’ branch, whereupon, at step 680, the process displays a dialog that allows the user to edit the user preferences, such as whether to prompt the user to indicate the user to which a browser action applies, as specified by user. The user's preferences are stored in the user's profile in data store 325. On the other hand, if the user has not requested to edit the user's preferences, then decision 660 branches to the ‘no’ branch and processing returns to the calling routine (see FIG. 5) at 670. FIG. 6 processing thereafter returns to the calling routine (see FIG. 5) at 695.

While particular embodiments have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to others containing only one such element, even when the same claim includes the introductory phrases “one or more” or “at least one” and indefinite articles such as “a” or “an”; the same holds true for the use in the claims of definite articles.

What is claimed is:

1. A machine-implemented method comprising:
identifying a first user of an online session, wherein the first user is associated with a first set of user metadata;
receiving a request at the online session;
comparing the request to the first set of user metadata; and
associating the request to the first set of user metadata in response to the comparison revealing that the request pertains to the first set of user metadata.

2. The method of claim 1 wherein the first set of user metadata includes a first user history that includes a first plurality of prior user requests made by the first user.

3. The method of claim 2 further comprising:
computing a confidence score as a result of the comparison, wherein the request is associated to the first set of user metadata in response to the confidence score exceeding a threshold, and wherein the associating includes storing the received request in the first user history.

4. The method of claim 1 further comprising:
in response to the comparison failing to reveal that the request pertains to the first set of user metadata:
comparing the request to a plurality of sets of user metadata, wherein the plurality of sets of user metadata includes the first set of user metadata and a second set of user metadata;
based on the comparison to the plurality of sets of user metadata, identifying the second set of user metadata as pertaining to the request; and
associating the request to the second set of user metadata, wherein the second set of user metadata corresponds to a second user.

5. The method of claim 1 further comprising:
in response to the comparison failing to reveal that the request pertains to the first set of user metadata:
displaying a list of a plurality of users, wherein the plurality of users includes the first user and a second user, and wherein the second user is associated with a second set of user metadata;
receiving an indication from the first user that the received action pertains to the second user; and
associating the request to the second set of user metadata in response to the received indication.

6. The method of claim 5 further comprising:
prior to the displaying:
comparing the request to a plurality of sets of user metadata, wherein the plurality of sets of user metadata includes the first set of user metadata and the second set of user metadata, and wherein each of the plurality of sets of user metadata is associated with one of the plurality of users; and
computing a plurality of confidence scores as a result of the comparisons, wherein each of the confidence scores corresponds to a different one of the plurality of sets of user metadata, wherein the displaying further displays the list of the plurality of users based on the confidence scores pertaining to each of the plurality of users.

7. The method of claim 1 further comprising:
in response to the comparison failing to reveal that the request pertains to the first set of user metadata:
displaying a list of a plurality of users, wherein the plurality of users includes the first user;
receiving an indication from the first user that the received action is unassociated; and
inhibiting association of the request to any of the plurality of users in response to the received indication.

8. An information handling system comprising:
one or more processors;
a memory coupled to at least one of the processors; and
a set of instructions stored in the memory and executed by at least one of the processors to:
identify a first user of an online session, wherein the first user is associated with a first set of user metadata;
receive a request at the online session;
compare the request to the first set of user metadata; and
associate the request to the first set of user metadata in response to the comparison revealing that the request pertains to the first set of user metadata.

9. The information handling system of claim 8 wherein the first set of user metadata includes a first user history that includes a first plurality of prior user requests made by the first user.

10. The information handling system of claim 9 wherein the set of instructions further comprise further instructions executed by at least one of the processors to:
compute a confidence score as a result of the comparison, wherein the request is associated to the first set of user metadata in response to the confidence score exceeding a threshold, and wherein the association of the request stores the received request in the first user history.

11. The information handling system of claim 8 wherein the set of instructions further comprise further instructions executed by at least one of the processors to:
in response to the comparison failing to reveal that the request pertains to the first set of user metadata:
compare the request to a plurality of sets of user metadata, wherein the plurality of sets of user metadata includes the first set of user metadata and a second set of user metadata;
based on the comparison to the plurality of sets of user metadata, identify the second set of user metadata as pertaining to the request; and
associate the request to the second set of user metadata, wherein the second set of user metadata corresponds to a second user.

12. The information handling system of claim 8 wherein the set of instructions further comprise further instructions executed by at least one of the processors to:
in response to the comparison failing to reveal that the request pertains to the first set of user metadata:
display a list of a plurality of users on a display screen, wherein the plurality of users includes the first user and a second user, and wherein the second user is associated with a second set of user metadata;
receive an indication from the first user that the received action pertains to the second user; and
associate the request to the second set of user metadata in response to the received indication.

13. The information handling system of claim 12 wherein the set of instructions further comprise further instructions executed by at least one of the processors to:
prior to the display of the list:
compare the request to a plurality of sets of user metadata, wherein the plurality of sets of user metadata includes the first set of user metadata and the second set of user metadata, and wherein each of the plurality of sets of user metadata is associated with one of the plurality of users; and
compute a plurality of confidence scores as a result of the comparisons, wherein each of the confidence scores corresponds to a different one of the plurality of sets of user metadata, wherein the display of the list further displays the list of the plurality of users based on the confidence scores pertaining to each of the plurality of users.

14. The information handling system of claim 8 wherein the set of instructions further comprise further instructions executed by at least one of the processors to:
in response to the comparison failing to reveal that the request pertains to the first set of user metadata:
displaying a list of a plurality of users on a display, wherein the plurality of users includes the first user;
receiving an indication from the first user that the received action is unassociated; and
inhibiting association of the request to any of the plurality of users in response to the received indication.

15. A computer program product comprising:
a computer readable storage medium comprising a set of computer instructions, the computer instructions effective to:
identify a first user of an online session, wherein the first user is associated with a first set of user metadata;
receive a request at the online session;
compare the request to the first set of user metadata; and
associate the request to the first set of user metadata in response to the comparison revealing that the request pertains to the first set of user metadata.

16. The computer program product of claim 15 wherein the first set of user metadata includes a first user history that includes a first plurality of prior user requests made by the first user, and wherein the computer instructions are further effective to:
compute a confidence score as a result of the comparison, wherein the request is associated to the first set of user metadata in response to the confidence score exceeding a threshold, and wherein the association of the request stores the received request in the first user history.

17. The computer program product of claim 15 wherein the computer instructions are further effective to:
in response to the comparison failing to reveal that the request pertains to the first set of user metadata:
compare the request to a plurality of sets of user metadata, wherein the plurality of sets of user metadata includes the first set of user metadata and a second set of user metadata;
based on the comparison to the plurality of sets of user metadata, identify the second set of user metadata as pertaining to the request; and
associate the request to the second set of user metadata, wherein the second set of user metadata corresponds to a second user.

18. The computer program product of claim 15 wherein the computer instructions are further effective to:
in response to the comparison failing to reveal that the request pertains to the first set of user metadata:
display a list of a plurality of users on a display screen, wherein the plurality of users includes the first user and a second user, and wherein the second user is associated with a second set of user metadata;
receive an indication from the first user that the received action pertains to the second user; and
associate the request to the second set of user metadata in response to the received indication.

19. The computer program product of claim 12 wherein the computer instructions are further effective to:
prior to the display of the list:
compare the request to a plurality of sets of user metadata, wherein the plurality of sets of user metadata includes the first set of user metadata and the second set of user metadata, and wherein each of the plurality of sets of user metadata is associated with one of the plurality of users; and
compute a plurality of confidence scores as a result of the comparisons, wherein each of the confidence scores corresponds to a different one of the plurality of sets of user metadata, wherein the display of the list further displays the list of the plurality of users based on the confidence scores pertaining to each of the plurality of users.

20. The computer program product of claim 15 wherein the computer instructions are further effective to:
in response to the comparison failing to reveal that the request pertains to the first set of user metadata:
displaying a list of a plurality of users on a display, wherein the plurality of users includes the first user;
receiving an indication from the first user that the received action is unassociated; and
inhibiting association of the request to any of the plurality of users in response to the received indication.
